(19) United States
(12) Patent Application Publication
(10) Pub. No.: US 2010/0091933 A1
(43) Pub. Date: Apr. 15, 2010

(54) METHOD OF PRODUCING LARGE-GRAINED NUCLEAR FUEL PELLET BY CONTROLLING CHROME CATION SOLUBILITY IN UO2 LATTICE

(75) Inventors: Kun Woo SONG, Daejeon (KR); Ki Won KANG, Daejeon (KR); Jong Hun KIM, Daejeon (KR); Keon Sik KIM, Daejeon (KR); Jae Ho YANG, Daejeon (KR); Young Woo RHEE, Daejeon (KR)

Correspondence Address: VOLPE AND KOENIG, P.C., UNITED PLAZA, SUITE 1600, 30 SOUTH 17TH STREET, PHILADELPHIA, PA, 19103, US

(73) Assignees: KOREA ATOMIC ENERGY RESEARCH INSTITUTE, Daejeon (KR); KOREA HYDRO & NUCLEAR POWER CO. LTD., Seoul (KR)

(21) Appl. No.: 12/335,952

(22) Filed: Dec. 16, 2008

(30) Foreign Application Priority Data
Oct. 15, 2008 (KR) 10-2008-0101062

(51) Int. Cl. G21C 3/00

(52) U.S. Cl. 376/414

(57) ABSTRACT

In a method of producing large-grained nuclear fuel pellet, Cr-compound contained in an uranium oxide green pellet is reduced to Cr phase at 1,470° C. or below and maintained to the Cr phase, and the uranium oxide green pellet containing the Cr-compound is then sintered at 1,650° C.-1,800° C. in a gas atmosphere of oxygen potential at which Cr element in the uranium oxide green pellet becomes liquid phase.

### CROSS-REFERENCE TO RELATED APPLICATIONS

This application claims the priority of Korean Patent Application No. 2008-101062 filed on Oct. 15, 2008, in the Korean Intellectual Property Office, the disclosure of which is incorporated herein by reference.

### BACKGROUND OF THE INVENTION

1. Field of the Invention

The present invention relates to a method of producing nuclear fuel pellet, and more particularly, to a method of producing large-grained pellet by controlling chrome cation solubility in UO₂ lattice through the control of a sintering process of an uranium oxide green pellet containing Cr-compound as an additive.

2. Description of the Related Art

Nuclear power plant uses heat generated by nuclear fission of uranium, and an UO₂ sintered pellet is generally used as nuclear fuel for nuclear power plant. The UO₂ sintered pellet may be produced by sintering a green pellet, which is obtained by compressing uranium oxide powder, in a reducing gas atmosphere at about 1,700-1,800° C. for 2-8 hours. The UO₂ sintered pellet produced by such an existing method has a density of about 95.5% TD (theoretical density) and a grain size of about 6-10 μm.

Recently, high burn-up nuclear fuels have been developed, which are burnt for a long time in order to increase economic efficiency of nuclear fuel and reduce an amount of spent fuel. As the burn-up of nuclear fuel increases, a generation amount of fission gas such as xenon (Xe) and krypton (Kr) increases. The increased fission gas will increase stress in a cladding tube, which may deteriorate the safety of nuclear fuel. Accordingly, in order to overcome those limitations, fission gas must be released from the pellet as little as possible. A procedure of the fission gas has been known as follows. The fission gas is produced within grains and diffused to grain boundary, and exists as bubbles. When the fission gas reaches a predetermined amount, a bubble tunnel is formed along the grain boundary, and the fission gas is released from the pellet through the bubble tunnel. As the grain size of the pellet increases, the diffusion distance of fission gas to the grain boundary becomes longer. Therefore, the fission gas remains within the pellet for a longer time, thus reducing a released amount of the fission gas. Thus, high burn-up nuclear fuel pellet is required to increase the grain size.

In a process of producing the nuclear fuel pellet, various additive elements may be used for increasing the grain size of the pellet. Examples of the additive elements include Al, Cr, Ti, Nb, Mg, V, P, and Si. Such additives are added in a range of several ppm to several thousands ppm in weight with respect to uranium cation within the pellet, and an added amount may be different according to the additives. A method of growing grain of UO₂ nuclear fuel pellet by adding Cr element has been known. Cr cation is dissolved in UO₂ lattice to form point defects in the UO₂ lattice, making it easy to diffuse uranium cation.

However, the Cr-added UO₂ pellet produced by the above method has large grains, but has low effect in suppressing the fission gas release. According to the research results of Killeen et al. [Journal of Nuclear Materials, 88 (1980), p. 177-184] and Kashibe et al. [Journal of Nuclear Materials, 254 (1998), p. 234-242], it was reported that if Cr cation was dissolved to form defects in the UO₂ lattice, the diffusivity of the fission gas also increased in UO₂ during burn-up, and thus, the effect in suppressing the fission gas release was low.

A method for suppressing the fission gas release by forming Cr precipitate within UO₂ pellet matrix through the fabrication process control is disclosed in U.S. Pat. No. 5,999,585, entitled “Nuclear fuel having improved fission product retention properties”, issued to Framatome on Dec. 7, 1999. The methods proposed in U.S. Pat. No. 5,999,585 are as follows.

In the first method (process 1), nuclear fuel pellet in which Cr is precipitated is manufactured by keeping an uranium oxide green pellet containing Cr-compound at 1,700° C. for 4 hours in a dry hydrogen atmosphere having water/hydrogen gas ratio below 0.05%. In another method (process 2), a pellet is manufactured by keeping an uranium oxide green pellet containing Cr-compound at 1,700° C. for 4 hours in a wet hydrogen atmosphere having water/hydrogen gas ratio of 1.7%, and then, nuclear fuel pellet in which Cr is precipitated is manufactured by annealing the pellet at 1,300° C. for 5 hours in a dry hydrogen atmosphere having water/hydrogen ratio below 0.05%.

FIG. 1 is a temperature-oxygen potential graph illustrating Cr—O based equilibrium phase in several water/hydrogen gas ratio (R) of a sintering atmosphere according to temperature. This graph is abstracted from references [Journal of Nuclear Materials, 42 (1972), p. 117-121] and [Metallurgical Transactions B, 22B (1991), p. 225-232]. According to the graph, Cr-compound mixed in uranium oxide exists as three different phases, that is, Cr₂O₃, Cr, and CrO, according to water/hydrogen gas ratio (R) of the sintering atmosphere and temperature. Cr₂O₃ and Cr are solid phase, and CrO is liquid phase. Referring to the graph of FIG. 1, in the first method (process 1), Cr-compound is reduced to Cr at around 1,060° C. In this case, since Cr₂O₃ is reduced at a low temperature around 1,060° C., Cr₂O₃ is precipitated as Cr before it is dissolved in UO₂. In this method, since metallic Cr element is not dissolved in UO₂ or liquid phase is not formed during the sintering, grain growth does not occur so that the pellet has a small grain size.

In the second method (process 2), since Cr-compound exists as Cr₂O₃ phase up to about 1,690° C., some of Cr cations are solid-solved in UO₂ in this temperature range and thus consumed, and some of Cr₂O₃ which are not dissolved become liquid phase at 1,690° C. or higher. Cr cations are dissolved in UO₂ lattice if Cr-compound exists as oxide phase of Cr₂O₃, but they are not dissolved if Cr-compound is precipitated as metal phase of Cr. Also, the quantity of Cr element dissolved in UO₂ lattice is changed according to oxygen potential of the sintering atmosphere and temperature. As the temperature increases, the quantity of Cr element dissolved in UO₂ increases. Thus, In the second method (process 2) in which Cr-compound is maintained as Cr₂O₃ phase up to about 1,690° C., most of Cr-compound is dissolved and consumed so that the quantity of CrO liquid phase is reduced. In the UO₂ pellet, grain growth effect due to the Cr element is much higher when the liquid phase is formed than when Cr element is solid-solved or precipitated as solid phase. This is because material transfer through liquid phase is much easier than that through solid phase. Therefore, the second method (process 2) has much lower grain growth effect than the method which increases the formation of the liquid phase by suppressing the solid solution of the Cr cations so that the consumption of Cr element is prevented.

### SUMMARY OF THE INVENTION

An aspect of the present invention provides a method of producing large-grained nuclear fuel pellet by controlling chrome cation solubility in UO₂ lattice through the control of a sintering process of an uranium oxide green pellet containing Cr-compound.

According to an aspect of the present invention, there is provided a method of producing large-grained nuclear fuel pellet, comprising: sintering an uranium oxide green pellet containing Cr-compound such that the Cr-compound is reduced and maintained to Cr phase at 1,470° C. or below, and the uranium oxide green pellet is then sintered at 1,650° C.-1,800° C. in a gas atmosphere with oxygen potential at which Cr element in the uranium oxide green pellet becomes liquid phase.

The Cr-compound may include organic Cr-compound or inorganic Cr-compound containing Cr element. The Cr-compound may include at least one material selected from the group consisting of Cr-metal, Cr-oxide, Cr-nitrate, Cr-stearate, Cr-chloride, Cr-hydroxide, and Cr-fluoride.

Cr content within the uranium oxide green pellet may be 300-2500 μg/g, based on weight ratio (Cr/U) of Cr in the Cr-compound with respect to uranium in the uranium oxide green pellet.

The Cr phase and liquid phase may be determined based on a Cr—O based equilibrium phase diagram.

The oxygen potential of the gas atmosphere during the sintering of the uranium oxide green pellet may be controlled by using a hydrogen containing mixed gas, which contains hydrogen gas and at least one gas selected from the group consisting of carbon dioxide, vapor and inert gas, or hydrogen gas as an atmosphere control gas.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a graph illustrating Cr—O based equilibrium phase and oxygen potential of a sintering atmosphere according to temperature;

FIG. 2 schematically illustrates a Cr—O based equilibrium phase diagram in an exemplary sintering process; and

FIGS. 3A through 3C are photographs illustrating grain structures of UO₂ nuclear fuel pellet manufactured by the embodiment 1 and the comparative examples 1-1 and 1-2, respectively.

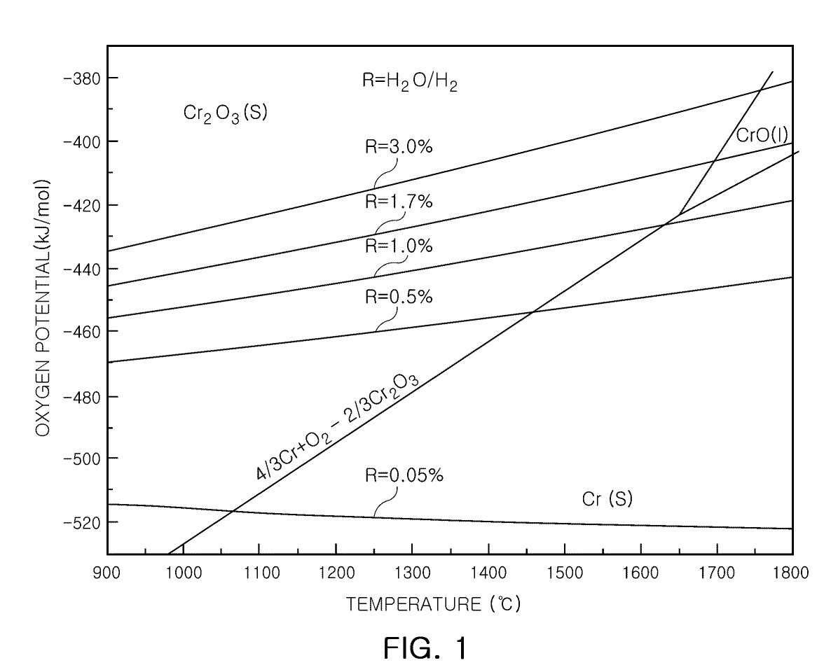

### DETAILED DESCRIPTION OF THE PREFERRED EMBODIMENT

Exemplary embodiments of the present invention will now be described in detail with reference to the accompanying drawings.

In order that UO₂ pellet produced by adding Cr element can effectively suppress fission gas release, solid solution of Cr cation in UO₂ lattice is controlled to prevent defects from being formed within UO₂ lattice. Also, much liquid phase is formed by suppressing consumption of Cr element. In this way, the large-grained UO₂ pellet is formed. The pellet produced in the above manner can solve the problem that increase the diffusivity of the fission gas due to the formation of UO₂ lattice defects due to the solid-solved Cr element, and can also effectively suppress fission gas release by lengthening the diffusion distance to the grain boundary due to the large grain size. In addition, since there is no consumption of Cr element due to the solid solution, the quantity of the liquid phase in the same added amount is increased much more than the related art method. Thus, the grain can be effectively grown by using a small amount of additive.

The inventors completed the invention related to a method of producing a pellet, which has a large grain and suppresses solid solution of Cr cation, by controlling a sintering process of an uranium oxide green pellet containing Cr-compound.

In order to obtain nuclear fuel pellet, uranium oxide powder in which Cr-compound is mixed is prepared by adding Cr-compound to uranium oxide powder. The uranium oxide powder in which the Cr-compound is mixed may be produced by a method of mixing or grinding uranium oxide powder and Cr-compound through a dry process or a wet process.

Thereafter, a green pellet is formed using the mixture (mixed powder of uranium oxide and Cr-compound). As is known to those of ordinary skill in the art, the green pellet may be formed by placing the uranium oxide power mixed with the Cr-compound into a mold and pressurizing it at a pressure of about 3-6 ton/cm².

Then, the uranium oxide green pellet containing the Cr-compound is sintered. In this case, the Cr-compound contained in the uranium oxide green pellet is reduced (and maintained) to Cr phase at 1,470° C. or below, and it is then sintered in a gas atmosphere with oxygen potential in which Cr element in the uranium oxide green pellet becomes liquid phase at 1,650-1,800° C.

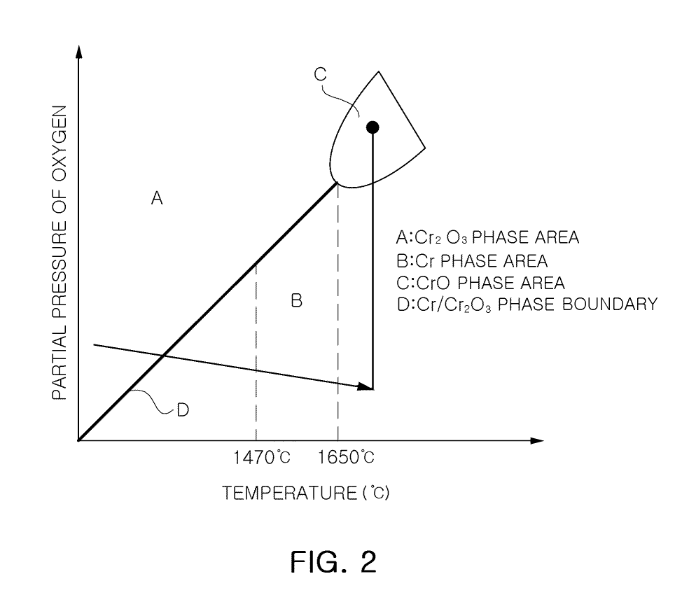

FIG. 2 schematically illustrates a Cr—O based equilibrium phase diagram in an exemplary sintering process. FIG. 2 illustrates stable areas of Cr, Cr₂O₃ and CrO phases of the Cr-compound mixed in the uranium oxide according to the oxygen potential and temperature.

In the sintering process, the Cr-compound is made to be reduced to Cr at 1,470° C. or below and maintained in order to suppress the solid solution of Cr cation in UO₂. The suppression of the solid solution can simultaneously solve the problem that the release rate of fission gas becomes fast due to the formation of defects in UO₂ and the problem that grain growth effect becomes low because Cr element is solid-solved and thus the quantity of liquid phase is reduced.

Cr element is dissolved in UO₂ lattice when it exists as Cr₂O₃ oxide phase, but it is not dissolved when it is precipitated as Cr phase. Also, the solubility of Cr element in UO₂ lattice is changed according to oxygen potential of the sintering atmosphere and temperature. As the temperature increases, the solubility of Cr element in UO₂ increases. According to the research results of A. Leenaers et al. [Journal of Nuclear Materials, 317 (2003), p. 62-68], it was reported that the solubility of Cr cations in UO₂ lattice rapidly increased at a temperature above 1,550° C. as the temperature rises.

In addition, in the experimental results of the inventors, Cr element was not dissolved in UO₂ lattice while it is maintained at 1,470° C. for 10 minutes in an atmosphere having a water/hydrogen gas ratio of 1.7%. Furthermore, the green pellet in which 600 weight ppm of Cr₂O₃ with respect to Cr/U was added to UO₂ is reduced to Cr at 1,630° C., 1,550° C. and 1,470° C. Then, the pellet was formed by controlling the atmosphere so that liquid phase could be formed. In this case, as the reducing temperature is lower, the grain size of the pellet became larger. This shows that the solid solution of Cr element in UO₂ matrix is suppressed by lowering the temperature at which Cr-compound contained in UO₂ is reduced to Cr, and the quantity of liquid phase increases so that the grain of the pellet is grown in a large size. Therefore, it is limited that Cr is reduced at lower than 1,470° C. at which Cr element is not dissolved in UO₂ matrix, and then is maintained.

In the sintering process, the sintering atmosphere of oxygen potential at which liquid phase of Cr element is formed is limited to 1,650° C.-1,800° C., in order to suppress the solid solution of Cr cation in UO₂ lattice and make most of the added Cr elements to liquid phase to thereby effectively produce the large-grained pellet. In the UO₂ pellet, the grain growth effect due to the Cr element is much higher when Cr element becomes liquid phase than when Cr element is solid-solved or precipitated. This is because material transfer through liquid phase is much faster than that through solid phase.

In the sintering process, the atmosphere control gas may be hydrogen gas, or a mixed gas of hydrogen gas and at least one gas selected from the group consisting of carbon dioxide, vapor and inert gas. The oxygen potential of the sintering atmosphere can be controlled by using the atmosphere control gas.

In order for further detailed comparison of the related art and the present invention, the related art sintering using uranium oxide green pellet mixed with Cr-compound will be described below in more detail.

First, the sintering is performed after Cr-compound is reduced to Cr before being dissolved in UO₂.

Second, the sintering is performed in the CrO liquid phase area after the Cr-compound is maintained in Cr₂O₃ phase until the temperature rises to high temperature.

Third, the sintering is performed while the Cr-compound is maintained in Cr₂O₃ phase.

Fourth, the annealing is performed on the pellet formed by the second method for several hours in the area where Cr phase is stable.

According to the first method, the Cr-compound is precipitated to Cr at a low temperature before it is dissolved in UO₂. Therefore, the Cr element is not dissolved or does not become liquid phase during the sintering process. Thus, the first method has a disadvantage that the pellet has a small grain size because the grain growth due to the Cr element does not occur.

According to the second method, the Cr-compound is maintained in Cr₂O₃ phase until just before high temperature at which liquid phase is formed. In this case, some of Cr cations are dissolved in UO₂ and thus consumed, and some of Cr₂O₃ which are not dissolved become CrO phase. Thus, the second method has a disadvantage that Cr element is dissolved to form UO₂ lattice defects and thus the diffusivity of fission gas becomes higher. Also, the second method has a disadvantage that Cr element is dissolved and consumed, so that the grain growth effect is lower than the method of making most additives become liquid phase by suppressing the solid solution.

According to the third method, Cr element is dissolved during the overall sintering process. Thus, the second method has a disadvantage that the diffusivity of fission gas becomes higher due to the formation of UO₂ lattice defects caused by the solid solution. Also, since the grain growth effect due to the solid solution is lower than that due to the liquid phase, a large grain is not effectively obtained using a small amount of Cr element.

According to the fourth method, Cr-compound is maintained as Cr₂O₃ phase until just before high temperature at which liquid phase is formed. Cr cation is dissolved in UO₂ and thus Cr element is consumed, so that the quantity of liquid phase is reduced. Consequently, the grain growth effect is low. While the annealing process is performed in the hydrogen atmosphere, the Cr element which is already dissolved in UO₂ or becomes liquid phase does not promote an additional grain growth. Furthermore, the fourth method has a disadvantage that a process is added because the pellet manufactured by the typical process must be again annealed in a high-temperature hydrogen atmosphere for a long time.

The Cr-component content of the uranium oxide powder may be 300-2,500 μg/g, based on weight ratio (Cr/U) of Cr in the Cr-component with respect to uranium in the uranium oxide powder. Using the Cr weight ratio in such a range, the solid solution of Cr element is suppressed and most of the added Cr elements become liquid phase. Thus, the grain growth can be effectively accelerated. Therefore, in such a pellet, the liquid phase is formed when the content of the added Cr element is below the solubility limit of Cr element contained in UO₂, as well as above the solubility limit. Consequently, the grain growth can occur even when the added amount is small.

The embodiments of the present invention will be described below in more detail. The following embodiments are merely exemplified and the scope of the present invention is not limited by those embodiments.

### Embodiment 1

600 μg/g of Cr₂O₃ powder, based on Cr/U, is added to UO₂ powder and is wet-grinded and dried to prepare a Cr₂O₃ mixed UO₂ powder.

The mixed powder is compressed at a pressure of 3 ton/cm² to produce a cylindrical green pellet.

The green pellet is heated up to 1,700° C. at a heating rate of 300° C. per hour under a dry hydrogen atmosphere having a water/hydrogen gas ratio below 0.05 volume % and is maintained for 4 hours under a wet hydrogen atmosphere having a water/hydrogen gas ratio of 1.7%. Thereafter, the sample is cooled down to room temperature under the same atmosphere to thereby produce UO₂ pellet.

In the above process, Cr₂O₃ mixed as an additive in UO₂ is thermodynamically reduced to metallic Cr at around 1,060° C., and the metallic Cr is changed to CrO liquid phase at 1,700° C. and maintained. And then, Cr-containing pellet is cooled to where Cr₂O₃ is a stable state.

The density of the manufactured pellet was measured using Archimedes's method. After the density measurement, a pore structure was observed by performing a mirror surface polishing on the cross section of the pellet, and a grain structure was observed by performing a thermal etching thereon. The grain size of the pellet was measured by a line intercept method.

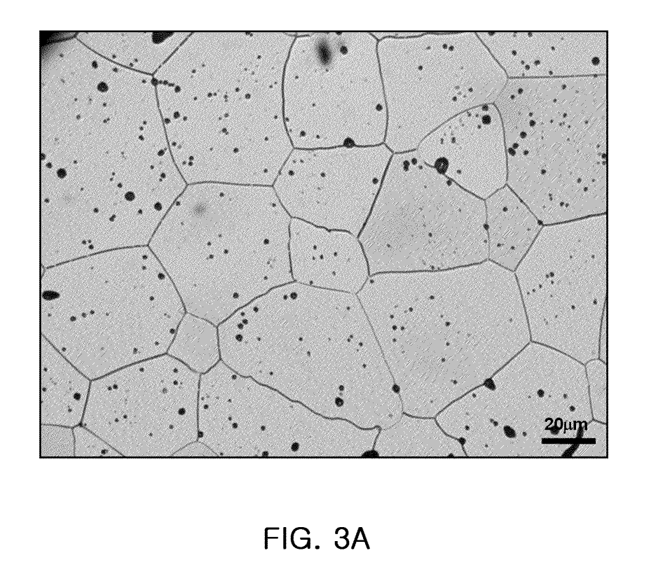

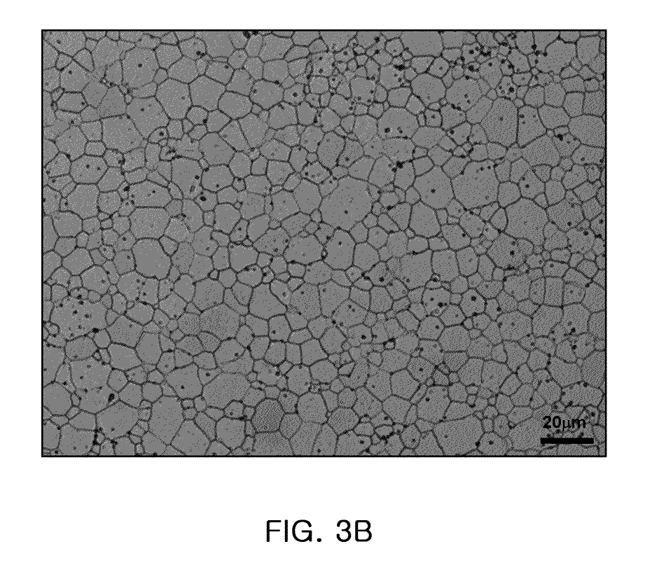

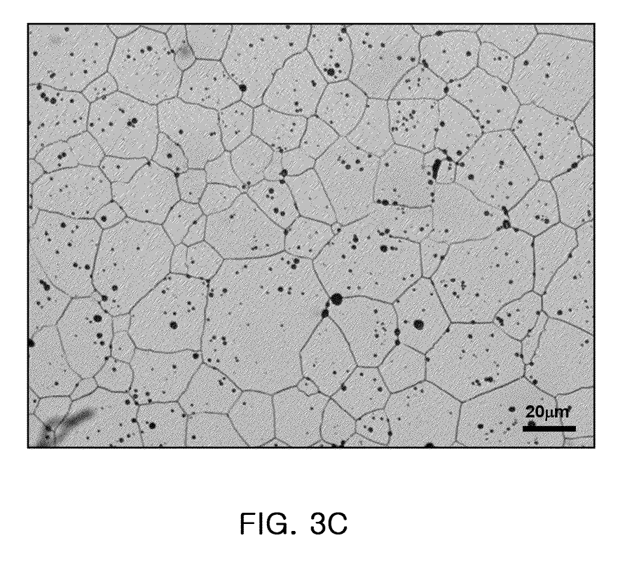

FIG. 3A is a photograph illustrating a grain structure of the pellet manufactured in the above method. The grain size of the pellet is 46 μm, which is about 2-6 times larger than those of the comparative examples 1-1, 1-2, 1-3 and 1-4.

### Comparative Example 1-1

UO₂ green pellet was manufactured under the same conditions as the embodiment 1.

The green pellet was heated up to 1,700° C. at a heating rate of 300° C. per hour under a dry hydrogen atmosphere having a water/hydrogen gas ratio below 0.05 volume % and was maintained for 4 hours. Thereafter, the sample was cooled down to room temperature at a rate of 300° C. per hour under the same atmosphere to thereby produce UO₂ pellet.

In the above process, Cr₂O₃ mixed as an additive in UO₂ was thermodynamically reduced to metallic Cr at around 1,060° C. in the Cr—O based phase diagram, and was sintered and cooled while being maintained in Cr phase up to 1,700° C.

FIG. 3B is a photograph illustrating a grain structure of the pellet manufactured in the above method (comparative example 1-1). The grain size of the pellet is 7.3 μm, which is about 6 times smaller than that of the embodiment 1.

Cr₂O₃ used as an additive is precipitated as metallic Cr at a relative low temperature before it is dissolved, and is continuously maintained in the Cr phase area. Thus, the added Cr element is not dissolved in UO₂ or the liquid phase is not formed. Therefore, the pellet has a small grain size because the grain growth does not occur.

### Comparative Example 1-2

UO₂ green pellet was manufactured under the same conditions as the embodiment 1.

The green pellet was heated up to 1,700° C. at a heating rate of 300° C. per hour under a wet hydrogen atmosphere having a water/hydrogen gas ratio of 1.7 volume % and was maintained for 4 hours. Thereafter, the green pellet was cooled down to room temperature at a rate of 300° C. per hour under the same atmosphere to thereby produce UO₂ pellet.

In the above process, Cr₂O₃ mixed as an additive in UO₂ was thermodynamically maintained as Cr₂O₃ phase up to about 1,060° C. in the Cr—O based phase diagram. Some of Cr₂O₃ were solid-solved and consumed, and Cr₂O₃ which was not dissolved in UO₂ becomes CrO phase at a temperature above 1,690° C.

FIG. 3C is a photograph illustrating a grain structure of the pellet manufactured in the above method (comparative example 1-2). The grain size of the pellet is 20 μm, which is about 2 times smaller than that of the embodiment 1.

This is because the added Cr-compound is maintained as Cr₂O₃ phase, which is soluble in UO₂, up to high temperature around 1,690° C., and thus, Cr cation is dissolved in UO₂ during temperature rise so that Cr element is consumed and the quantity of CrO liquid phase is reduced. Therefore, the grain growth effect is much lower than the embodiment 1 in which there is no loss of the Cr element due to the solid solution during the temperature rise.

### Comparative Example 1-3

UO₂ green pellet was manufactured under the same conditions as the embodiment 1.

UO₂ pellet was manufactured using the green pellet by the same method as the comparative example 1-2.

The UO₂ pellet was heated up to 1,300° C. at a heating rate of 300° C. per hour under a dry hydrogen atmosphere having a water/hydrogen gas ratio below 0.05 volume % and was annealed for 5 hours. Thereafter, the UO₂ pellet was cooled down to room temperature at a rate of 300° C. per hour under the same atmosphere.

The grain size of the pellet manufactured in the above method is 20.3 μm, which is similar to that of the comparative example 1-2 and is about two times smaller than that of the embodiment 1.

Since the added Cr-compound is maintained as Cr₂O₃ phase, which is soluble in UO₂, up to high temperature around 1, 690° C., Cr cation is solid-solved in UO₂ during temperature rise, so that Cr element is consumed and the quantity of CrO liquid phase is reduced.

Also, the grain growth does not occur due to Cr element, which is already solid-solved in UO₂ or in which liquid phase is formed, during the annealing process in which Cr element is precipitated as Cr metal. Thus, the grain size of the pellet is similar to that of the comparative example 1-2 and is smaller than that of the embodiment 1.

### Comparative Example 1-4

UO₂ green pellet was manufactured under the same conditions as the embodiment 1.

The green pellet was heated up to 1,700° C. at a heating rate of 300° C. per hour under a wet hydrogen atmosphere having a water/hydrogen gas ratio of 3.0 volume % and was maintained for 4 hours. Thereafter, the green pellet was cooled down to room temperature at a rate of 300° C. per hour under the same atmosphere to thereby produce UO₂ pellet.

In the above process, Cr₂O₃ mixed as an additive in UO₂ thermodynamically existed as only Cr₂O₃ phase during the overall sintering process in the Cr—O based phase diagram.

The grain size of the pellet manufactured by the above method is 12.8 μm, which is about 3.5 times smaller than that of the embodiment 1.

Since Cr₂O₃ used as an additive exists as only Cr₂O₃ phase, it is dissolved in UO₂, but liquid phase is not formed. Thus, the grain size of the pellet is smaller than that of the embodiment 1 or the comparative example 1-2.

According to the embodiments of the present invention, the large-grained pellet can be effectively manufactured by controlling Cr cation solubility in uranium oxide (UO₂) lattice. Such a UO₂ pellet can suppress the fission gas release during burn-up in a nuclear reactor, thereby increasing the stability of nuclear fuel at high burn-up.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of producing large-grained nuclear fuel pellet, comprising:
sintering an uranium oxide green pellet containing Cr-compound such that the Cr-compound contained in the uranium oxide green pellet is reduced and maintained to Cr phase at 1,470° C. or below, and the uranium oxide green pellet is then sintered at 1,650° C.-1,800° C. in a gas atmosphere with oxygen potential at which Cr element in the uranium oxide green pellet becomes liquid phase.

2. The method of claim 1, wherein the Cr-compound comprises organic Cr-compound or inorganic Cr-compound containing Cr element.

3. The method of claim 2, wherein the Cr-compound comprises at least one material selected from the group consisting of Cr-metal, Cr-oxide, Cr-nitrate, Cr-stearate, Cr-chloride, Cr-hydroxide, and Cr-fluoride.

4. The method of claim 1, wherein Cr content in the uranium oxide green pellet is 300-2500 μg/g, based on weight ratio (Cr/U) of Cr in the Cr-compound respect to uranium of the uranium oxide green pellet.

5. The method of claim 1, wherein the Cr phase and liquid phase are determined based on a Cr—O based equilibrium phase diagram.

6. The method of claim 1, wherein the oxygen potential of the gas atmosphere during the sintering of the uranium oxide green pellet is controlled by using a hydrogen containing mixed gas, which contains hydrogen gas and at least one gas selected from the group consisting of carbon dioxide, vapor and inert gas, or hydrogen gas as an atmosphere control gas.
